(19) United States
(12) Patent Application Publication
(10) Pub. No.: US 2007/0121201 A1
(43) Pub. Date: May 31, 2007

(54) Stereomicroscope

(76) Inventor: Ulrich Sander, Rebstein (CH)

Correspondence Address: HODGSON RUSS LLP, ONE M & T PLAZA, SUITE 2000, BUFFALO, NY, 14203-2391, US

(21) Appl. No.: 11/562,574

(22) Filed: Nov. 22, 2006

(30) Foreign Application Priority Data
Nov. 25, 2005 (DE) 10 2005 056 235.3

(51) Int. Cl. G02B 21/22

(52) U.S. Cl. 359/377

(57) ABSTRACT

A stereomicroscope (1) is disclosed, having a main objective (2) which defines an optical viewing path and determines a beam base (16a) on an object (16) which is to be examined. In addition, at least one deflecting element is provided which deflects the optical viewing path coming from the main objective (2). At least one of the deflecting elements is provided with a deformable mirror surface, the deflecting element being connected to a control unit (32) for adjusting the deformable mirror surface.

### CROSS REFERENCE TO RELATED APPLICATIONS

This application claims priority of German patent application no. 10 2005 056 235.3 filed Nov. 25, 2005, which is incorporated by reference herein.

### FIELD OF THE INVENTION

The invention relates to a stereomicroscope. In particular, the invention relates to a stereomicroscope with a main objective which defines an optical viewing path and fixes or determines a beam base on an object which is to be examined. A zoom system and at least one deflecting element are provided in the optical viewing path. The deflecting element deflects the optical viewing path coming from the main objective.

### BACKGROUND OF THE INVENTION

Published German application DE 10255960 A1 discloses a stereomicroscope with a binocular tube for a main observer and a second observer. In addition, other ports are provided for other observers. In order to supply all possible observers with an image of the object, a plurality of deflecting elements for the optical viewing path are provided in the stereomicroscope.

If the base of the viewing beam on the surface of the object is to be changed, it is necessary to move the entire stereomicroscope. A shifting mechanism required for this purpose has to be substantial in its construction in order to move the large mass of the stereomicroscope.

The surgical microscope of Type M690 sold by the company Leica comprises a motor-driven horizontal shifting mechanism. By means of the X/Y coupling an adjustment range of the microscope is obtained in a window of 58×58 mm. The adjustment may be controlled, for example, using a foot-operated switch. The horizontal shift does have some advantages but because of the X/Y coupling it also has the disadvantage that the weight of the system is increased, so that achieving a balance of weight is complex. In addition, the surgical microscope also has to be protected from the impact of the forces produced by the X/Y adjustment. This is expensive to achieve. Moreover, the mechanical horizontal shifting mechanism is bulky.

### SUMMARY OF THE INVENTION

The problem of the invention is to provide a stereomicroscope with which the adjustment of the base of the optical viewing path can be carried out without the use of a complicated adjustment mechanism.

This problem is solved by a stereomicroscope embodying the present invention.

It is advantageous if at least one of the deflecting elements is a mirror with a deformable mirror surface, and if the deflecting element is connected to a control unit for the adjustment of the deformable mirror surface.

The X/Y adjustment of the beam base on the surface of the object can be carried out by suitable deformation of the mirror surface. It is also possible for the X/Y adjustment of the mirror surface to be carried out by means of two separate mirror surfaces arranged in the optical path of the stereomicroscope. The adjustment in the X direction is carried out by one mirror and the adjustment in the Y direction by another mirror. As the optical viewing path extends from the object toward an observer, the deflecting element is provided behind the main objective and the second deflecting element is provided in front of the zoom system. Both deflecting elements are provided with a deformable mirror surface.

The deformable mirror surface may be arranged on different deflecting elements in the optical path of the stereomicroscope. Essentially, the deformable mirror surface is provided in front of the zoom system. “In front of” means that, beginning at the object, the optical viewing path runs through the zoom system after it has been deflected at the deformable mirror surface.

The deformable mirror surface provided on the minimum of one deflecting element is in the form of an array of micromirrors. The micromirror array is a two-dimensional matrix of a plurality of individual mirrors.

Other advantageous embodiments of the invention are disclosed.

### BRIEF DESCRIPTION OF THE DRAWINGS

The subject-matter of the invention is diagrammatically shown in the drawings and described in more detail hereinafter with reference to the Figures, wherein:

FIG. 1 shows a schematic structure of a stereomicroscope with a number of ports for assistant observers, the stereomicroscope embodying the invention;

FIG. 2 shows a schematic view of a micromirror array made up of a plurality of small mirrors which thus constitute a reflective surface;

FIG. 3 is a sectional view of the micromirror array along the line A-A in FIG. 2, in which some of the small individual mirrors have been adjusted;

FIG. 4 shows an embodiment of the schematic structure of a stereomicroscope having a number of ports for assistant observers, the stereomicroscope embodying the invention; and

FIG. 5 shows another embodiment of the schematic structure of a stereomicroscope with a number of ports for assistant observers, the stereomicroscope embodying the invention.

### DETAILED DESCRIPTION OF THE INVENTION

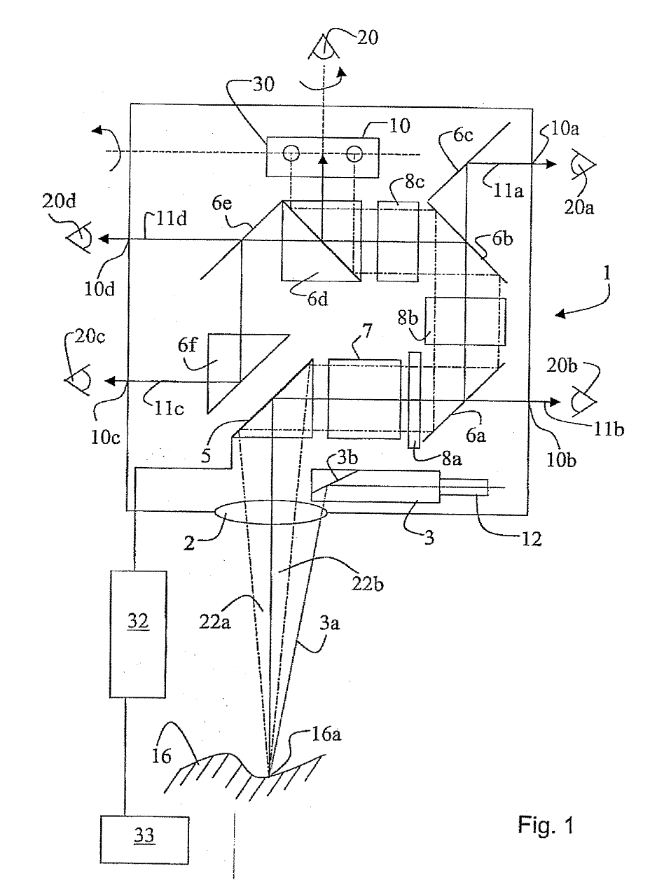

FIG. 1 shows a schematic structure of a stereomicroscope 1 having a plurality of ports 10, 10a, 10b, 10c, 10d for a number of observers 20, 20a, 20b, 20c, 20d. There may be one or more main observers and one or more assistant observers. The port 10 may be constructed with a pivotable deflecting element 30. The stereomicroscope 1 has a main objective 2 with which an object 16 can be viewed. The stereomicroscope 1 is, in particular, a surgical microscope, e.g. for ophthalmology. The main objective 2 defines an optical viewing path which fixes a beam base 16a on the object 16. In addition to the main objective, a zoom system 7 is provided in the optical viewing path inside the stereomicroscope 1. A first deflecting element 5 is provided between the main objective 2 and the zoom system 7. If necessary, a number of other deflecting elements 6a, 6b, 6c, 6d, 6e, 6f may be provided downstream of the zoom system 7. The deflecting elements 6a, 6b, 6c, 6d, 6e, 6f each serve to direct part of the optical viewing path to the corresponding port 10, 10a, 10b, 10c, 10d. Also provided in the optical viewing path are other optical components 8a, 8b, 8c which may be in the form of filters, optical imaging elements or controllable shutters or diaphragms.

In the stereomicroscope 1 is provided an illuminating device 3 which directs light 3a onto the object 16 for examination, for additional illumination. The light 3a from the illuminating device 3 can be provided through an optical fibre 12. The light 3a from the illuminating device 3 can be directed onto the object 16 through the main objective 2 via a deflecting element 3b. This illuminating device is one possibility out of a number of possible lighting methods. Thus, it is conceivable for the light source to be integrated in the microscope.

Two main viewing beam pencils 22a and 22b pass substantially vertically through the main objective 2. The viewing beam pencils 11a, 11b, 11c, 11d are also guided along the main viewing beam pencils 22a and 22b, the viewing beam pencils 11a, 11b, 11c and 11d being guided to the respective ports 10a, 10b, 10c, 10d, through which the assistants 20a, 20b, 20c, 20d or additional observers are provided with an image of the object 16. The light is supplied to the main operator 20 through the deflecting element 6d. The main operator 20 observes the object 16 through a rotatable deflecting element 30 which can be pivoted in the desired manner.

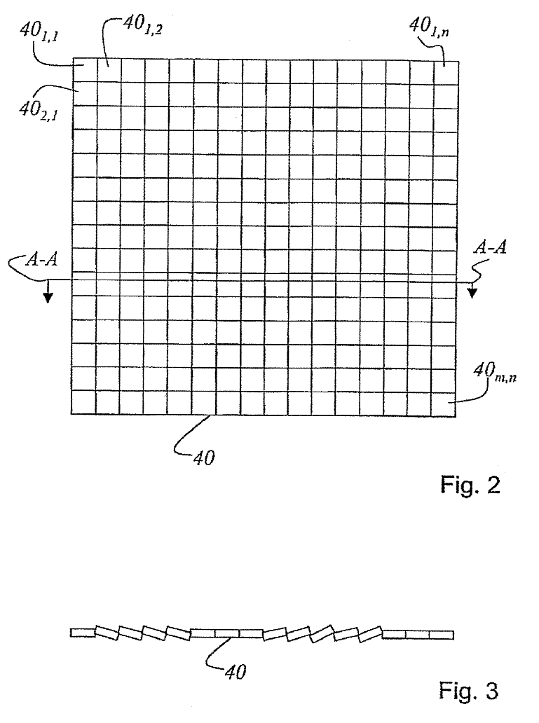

At least one of the deflecting elements 5, 6a, 6b, 6c, 6d, 6e, 6f is constructed as a deformable mirror surface. In the embodiment shown in FIG. 1 the deflecting element 5 is provided with the deformable mirror surface. The deflecting element 5 is connected to a control unit 32 for the adjustment of the mirror surface. In a preferred embodiment the deflecting element 5 and hence the deformable mirror surface is constructed as a micromirror array 40 (see FIG. 2). The control unit 32 is also connected to a switching element 33 which is constructed, for example, as a foot-operated switch or as a manual console or as a remote control or a voice-activated control or an eye-tracking system. The control unit 32 can be actuated by means of the switching element 33 so as to achieve the desired adjustment of the micromirror array 40. By suitable adjustment of the micromirror array the positioning of the beam base 16a of the optical viewing path on the object 16 is altered. Depending on the selected setting the beam base can be adjusted on the object 16 in the X/Y plane. Thus, one or more users are able to change the beam base on the surface without altering the position of the stereomicroscope 1.

FIG. 2 shows a schematic view of a micromirror array 40 made up of a plurality of small mirrors 40_{1,1}, 40_{1,2}, . . . , 40_{1,n}, . . . 40_{m,n}. The small mirrors 40_{1,1}, 40_{1,2}, . . . , 40_{1,n}, . . . 40_{m,n} are arranged in a two dimensional matrix. The individual mirrors 40_{1,1}, 40_{1,2}, . . . , 40_{1,n}, . . . 40_{m,n} are controlled by the control unit 32 such that the angular position of the mirrors in question is altered. Thus, individual mirrors of the micromirror array 40 can be adjusted so that the light striking this area of the reflective surface is deflected in another direction. This results, as already mentioned, in a shifting of the beam base 16a on the object 16.

FIG. 3 shows a sectional view of the micromirror array 40 along the line A-A in FIG. 2, in which some of the small individual mirrors have been moved.

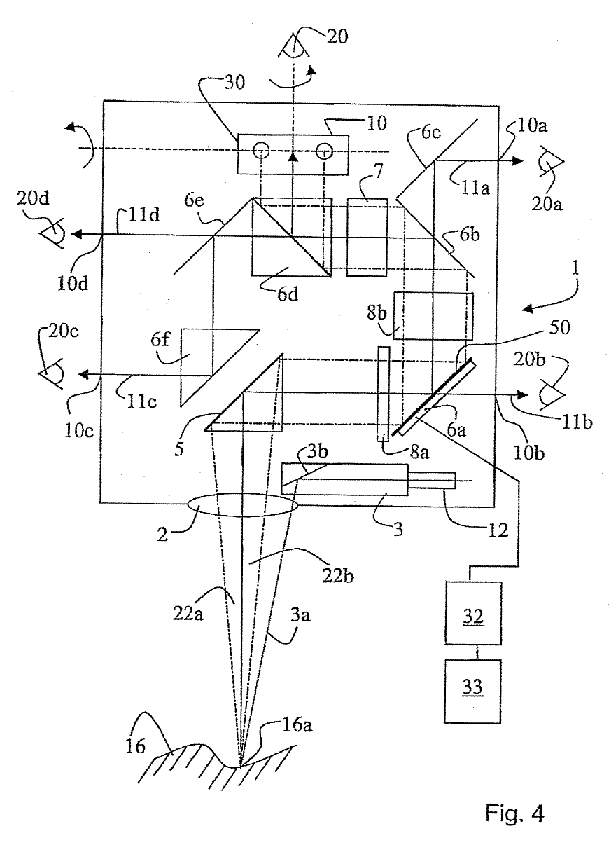

FIG. 4 shows another embodiment of the schematic structure of a stereomicroscope 1 having a plurality of ports 10, 10a, 10b, 10c, 10d for a number of observers 20, 20a, 20b, 20c, 20d, the stereomicroscope 1 embodying the invention. Here, the deformable mirror surface is not provided on the main deflecting element 5. The deformable mirror surface 50 in this embodiment is provided either on the deflecting element 6a or on the deflecting element 6b. The choice of which deflecting element 6a or 6b is provided with the deformable mirror surface depends on the overall design of the stereomicroscope 1. If the deformable mirror surface is on the deflecting element 6a or on the deflecting element 6b it is more favourable to position the zoom system 7 between the deflecting element 6b and the deflecting element 6d. Thus, the zoom system 7 is arranged behind the deformable mirror surface 50 as the optical viewing path travels from the object to an observer.

Basically, it is possible to equip any of the deflecting elements 5, 6a, 6b, 6c, 6d, 6e, 6f provided in the stereomicroscope 1 with the deformable mirror surface.

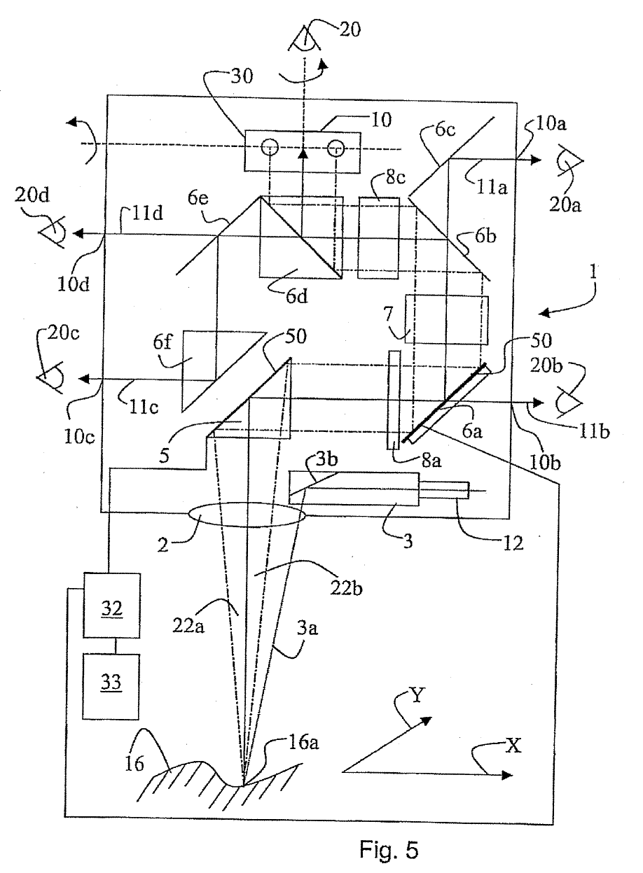

FIG. 5 shows a stereomicroscope 1 in which two deformable mirror surfaces have been provided on different deflecting elements. In the embodiment described here, the deflecting element 5 provided behind the main objective 2 and the deflecting element 6a provided in front of the zoom system 7 are each equipped with a deformable mirror surface 50. Thus, with the deformable mirror surface 50 on the deflecting element 5, the beam base 16a can be deflected, for example, in the X direction X and with the deformable mirror surface 50 on the deflecting element 6a it can be deflected in the Y direction Y.

What is claimed is:

1. A stereomicroscope comprising:
a main objective defining an optical viewing path and determining a beam base on an object to be observed;
a deflecting element which deflects the optical viewing path coming from the main objective, wherein the deflecting element is a mirror including a deformable mirror surface; and
a control unit connected to the deflecting element for adjusting the deformable mirror surface of the deflecting element.

2. The stereomicroscope according to claim 1, further comprising a zoom system arranged behind the deflecting element in the optical viewing path.

3. The stereomicroscope according to claim 2, wherein the deflection element is arranged behind the objective and in front of the zoom system in the optical viewing path, and the stereomicroscope further comprises an additional deflection element behind the deflection element and in front of the zoom system in the optical viewing path, the additional deflection element deflecting the optical viewing path coming from the deflection element, wherein the additional deflecting element is a mirror including a deformable mirror surface and the control unit is further connected to the additional deflecting element for adjusting the deformable mirror surface of the additional deflecting element.

4. The stereomicroscope according to claim 1, wherein the deformable mirror surface is defined by a micromirror array.

5. The stereomicroscope according to claim 4, wherein the micromirror array is a two-dimensional matrix of a plurality of individual mirrors.

6. The stereomicroscope according to claim 1, further comprising a switching element connected to the control unit for enabling a user to actuate the control unit to achieve a desired adjustment of the deformable mirror surface of the deflecting element.

7. The stereomicroscope according to claim 6, wherein the switching element includes a foot-operated switch.

8. The stereomicroscope according to claim 6, wherein the switching element includes a manual console.

9. The stereomicroscope according to claim 6, wherein the switching element includes a remote control.

10. The stereomicroscope according to claim 6, wherein the switching element includes a voice-activated control.

11. The stereomicroscope according to claim 6, wherein the switching element includes an eye tracking system.

12. The stereomicroscope according to claim 1, wherein the stereomicroscope is a surgical microscope.

13. The stereomicroscope according to claim 1, wherein the deformable mirror surface adjusts a location of the beam base on an object in an X direction and in a Y direction.
